(19) United States
(12) Patent Application Publication
(10) Pub. No.: US 2018/0300828 A1
(43) Pub. Date: Oct. 18, 2018

(54) Method for Collecting and Populating Forms between a Client and a Legal Professional

(71) Applicant: Tommy Songfong Wang, City of Industry, CA (US)

(72) Inventor: Tommy Songfong Wang, City of Industry, CA (US)

(21) Appl. No.: 15/916,158

(22) Filed: Mar. 8, 2018

Related U.S. Application Data
(63) Continuation-in-part of application No. 15/488,331, filed on Apr. 14, 2017.

(51) Int. Cl. G06Q 50/18; G06F 17/30; G06Q 20/22; G06F 17/24

(52) U.S. Cl. CPC G06Q 50/18; G06F 17/30598; G06F 17/243; G06Q 20/22; G06F 17/30011

(57) ABSTRACT

The present application discloses a method for collecting and populating forms between the client and the legal professional. The method includes: providing an editable legal disclosure form for the client; populating the editable legal disclosure form by the client; transferring the populated legal disclosure form to be an aggregated form via a server, wherein the server comprises a processor and a memory coupled to the processor, the memory comprises an object-oriented program; and reviewing the aggregated form by the legal professional.

### TECHNICAL FIELD OF THE INVENTION

The present application generally relates to a method between a client and a legal professional, and more particularly, to a method for collecting and populating forms between the client and the legal professional.

### BACKGROUND OF THE INVENTION

Typically, a potential legal client who requires legal assistance must contact and disclose information to an attorney. The attorney must process this information to determine the optimal legal route for the client. From the attorney perspective, the client-attorney communication often requires significant administrative overhead on the part of the attorney and legal staff. It is known in the legal field that coordinating meetings, collating documents, and disseminating information takes considerable time and resources. In addition, the legally pertinent information can be difficult to transfer to the attorney; especially for a client that is not familiar with legal methods. Furthermore, even if the client sends the legally pertinent information to the attorney, it is common that the legally pertinent information is wrong or not qualified for drafting official documents.

Therefore, a need remains for a method for collecting and populating forms between the client and the legal professional to allow the client and the attorney to have more efficient way for handling legal matters.

### SUMMARY OF THE INVENTION

The present application discloses a method for collecting and populating forms between the client and the legal professional to allow the client and the attorney to have more efficient way for handling legal matters.

The method for collecting and populating forms between the client and the legal professional, comprising providing an editable legal disclosure form for the client; populating the editable legal disclosure form by the client; transferring the populated legal disclosure form to be an aggregated form via a server, wherein the server comprises a processor and a memory coupled to the processor, the memory comprises an object-oriented program; and reviewing the aggregated form by the legal professional.

In various exemplary embodiments, before populating the editable legal disclosure form by the client, the method further comprises downloading the editable legal disclosure form by the client via an electronic device. The electronic device is a mobile communication device, wherein the mobile communication device is a smart phone, a tablet or a digital personal assistant.

In various exemplary embodiments, the step of transferring the populated legal disclosure form to be the aggregated form via the server comprises creating a relationship between the editable legal disclosure form and the aggregated form, wherein the editable legal disclosure form comprises a personal information part, a legal information part and a legally pertinent file part, wherein the legal information part and the legally pertinent file part relate to a legal matter; transmitting the populated legal disclosure form to the memory; creating an object for the client via the processor; creating at least one class within the object via the processor; classifying the client into the object according to the personal information part; classifying the legal matter into the at least one class according to the legal information part; extracting a personal information from the personal information part, a legal information from the legal information part and a legally pertinent file from the legally pertinent file part into an aggregate data; compiling the aggregate data into the aggregated form. In addition, after creating the relationship between the editable legal disclosure form and the aggregated form, the method further comprises confirming a filename extension of the legally pertinent file.

In various exemplary embodiments, after transferring the populated legal disclosure form to be the aggregated form via the server, the method further comprises printing the aggregated form; and sending the aggregated form to a legal entity.

In various exemplary embodiments, wherein the step of providing the editable legal disclosure form for the client comprises providing a retainer agreement for the client; and accepting the retainer agreement by the client. The retainer agreement comprises a full payment term or a partial payment term.

In various exemplary embodiments, before providing the editable legal disclosure form for the client, the method further comprises logging in to the server by the client.

In various exemplary embodiments, before providing the editable legal disclosure form for the client, the method further comprises selecting the legal professional by the client.

In various exemplary embodiments, after reviewing the aggregated form by the legal professional, the method further comprises notifying the client for an additional information by the legal professional.

Based on the above, the present application allows the client to choose the trusted legal professional in a more efficient way since the client can select the attorneys simply via the electronic device. In addition, due to the utilization of the object-oriented program, the populated legal disclosure form can be transferred into the aggregated form which is more formal and clearer for the legal professional, reducing previous complex and time-consuming procedure.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 illustrates a view of an exemplary system for collecting and populating forms between the client and the legal professional.

FIGS. 2A-2C illustrate flow charts of a method thereof.

FIGS. 3A-3B illustrate views of an exemplary object-oriented program.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

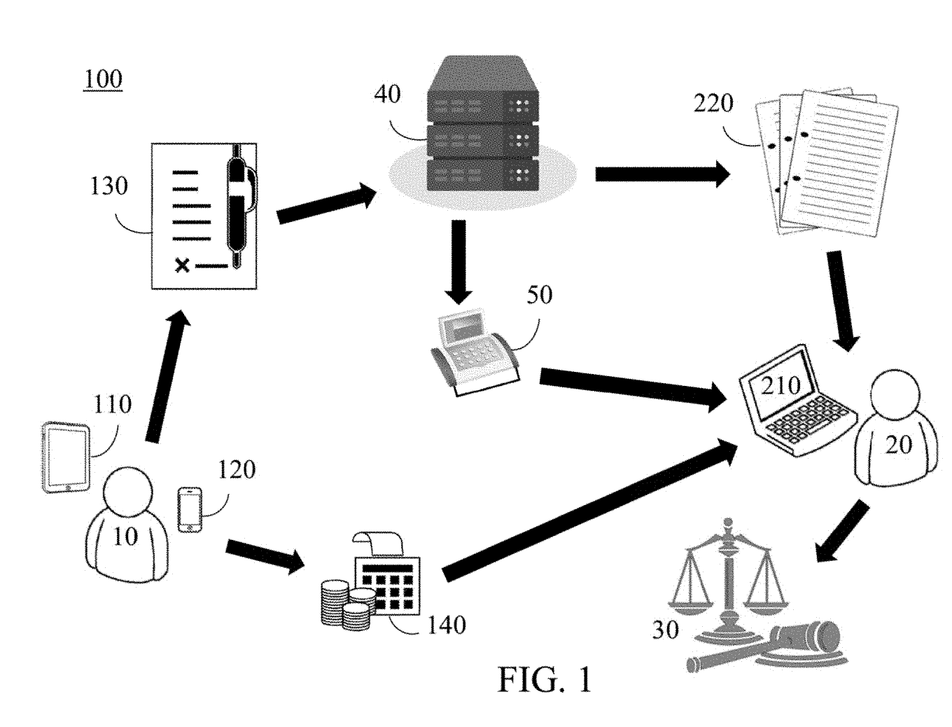

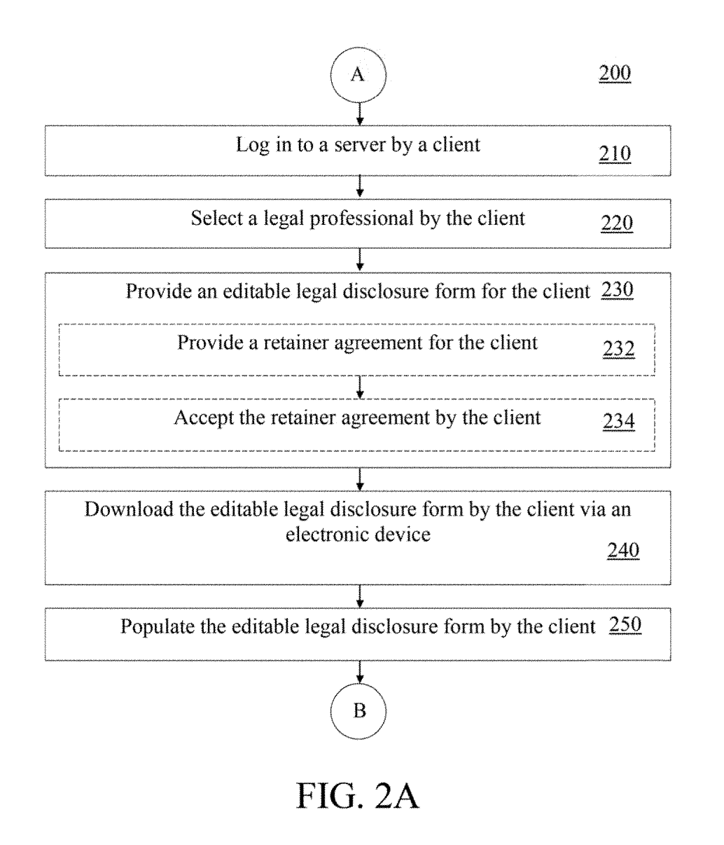

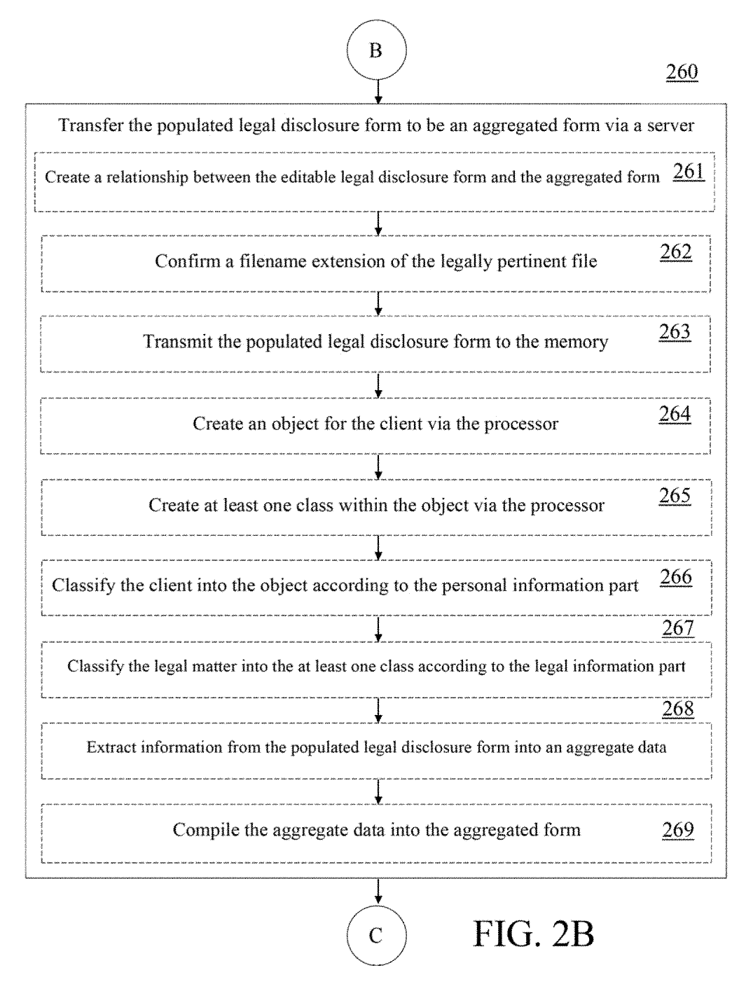

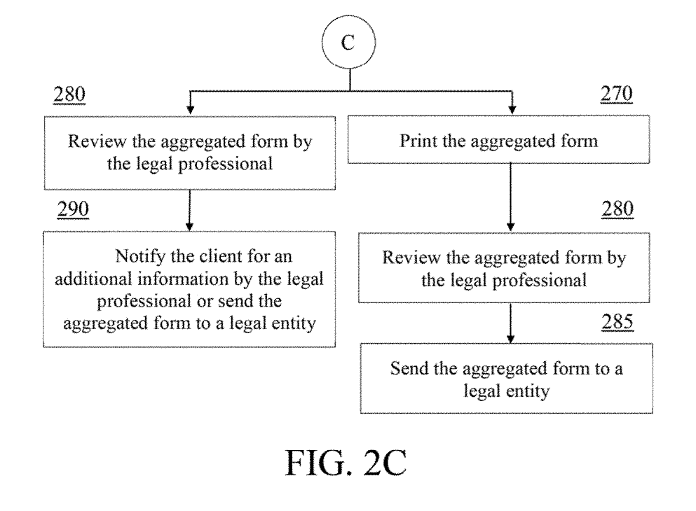

FIG. 1 illustrates a view of an exemplary system 100 for collecting and populating forms between the client 10 and the legal professional 20. FIGS. 2A-2C illustrate flow charts of a method thereof.

The system 100 and the method 200 for collecting and populating forms between the client 10 and the legal professional 20 are referenced in FIGS. 1-2C. The system 100 and the method 200 for collecting and populating legal forms between the client 10 and the legal professional 20, hereafter “system 100” and “method 200” enables the legal professional 20 to work efficiently with the potential client 10 while representing for a legal matter; and allows the client 10 to efficiently provide legally pertinent information to the legal professional 20 in a uniform format through use of an electronic device. This interactive relationship streamlines the communications between the client 10, the legal professional 20 and a legal entity 30.

Referring to FIGS. 1 and 2A, there are three parties, the client 10, the legal professional 20 and the legal entity 30 interacting in the system 100. Specifically, as shown in step 210, the client 20 may log in to a server 40 via the electronic device. The electronic device 100 may be a mobile communication device such as a tablet 110, a smart phone 120, a laptop (not shown), to computer (not shown) or digital personal assistant. The present application is not limited by the type of the electronic device. After that, the server 40 may automatically pull out all of the information of the client 10 and jump to the client's private interface if the server 40 already saves the information of the client 10.

It should be noted that the present application is not limited in submitting the documents stored in the above-mentioned electronic device. For example, if the client would like to submit a scan-needed document, he/she can use a scannable machine such as a printer or a fax machine. The scannable machine is connected to the electronic device either by a cable or wirelessly, allowing the client 10 to submit the scanned-document directly.

Next, as shown in step 220, the client 10 may select a desired legal professional. That is, the client 10 may pre-store several legal professionals according to their areas of expertise. In this case, only the selected legal professional 20 can review the case. Furthermore, the client 10 may also block the specific legal professional(s) from reviewing his/her case during the step 220, reminding the client 10 from selecting the specific legal professional(s) while submitting the documents for the same case next time. The legal professional of the present application can be a notary public, attorney or translator etc.

As shown in step 230, the system 100 then may provide an editable legal disclosure form 130 for the client 10. Specifically, the editable legal disclosure form 130 comprises at least a personal information part, a legal information part and a legally pertinent file part. The legal disclosure form 130 is not an official form but a simple and more user friendly form, which means the client 10 can populate it without reading complex rules or being confused by the terminology.

The personal information part allows the client 10 to fill in his/her personal information such as name, address, phone number, contact information, credit card information or email etc.

The legal information part allows the client 10 to describe the legal matter. Specifically, the legal information part comprises multiple portions such as immigration portion, patent portion, trademark portion, contract portion etc. Each portion comprises different blanks. For instance, the immigration portion may comprise current visa status blank, marital status blank, application type blank, family members blank etc.; the patent portion may comprise application type blank, background blank or invention description blank etc.; the trademark portion may comprise application type blank, applied item(s) blank or applicant(s) information blank etc.; the contract portion may comprise price amount blank or dispute type blank etc. The present application is not limited by the content of the blanks.

The legally pertinent file part allows the client 10 to upload to or delete the files. For example, the client 10 may upload his/her current visa document if he/she would like to apply for a working visa, or the client 10 may delete and re-upload the figures after amendment of a patent application.

As shown in step 232, the system 100 may also provide a retainer agreement 140 for the client 10 with the editable legal disclosure form 130. Specifically, the retainer agreement 140 may comprise a full payment term or a partial payment term. For the retainer agreement 140 comprising full payment term, the client 10 should pay full amount of application fee and service fee to the legal professional 20 when authorizing the legal professional 20 to handle his/her case. For the retainer agreement 140 comprising partial payment term, the client 10 may only pay the partial service fee and pay the rest after the legal professional 20 finishes the application. However, the patent application is not limited, the client 10 may also pay the rest of the payment at another time. In addition, the client 10 may also pay the rest of payment at multiple times, the present application is not limited by the payment time and frequency.

As shown in step 234, the client 10 then accepts the retainer agreement 140 to officially create the authorization relationship.

As shown in step 240 and step 250, the client 10 then can download the editable legal disclosure 130 and populate it via the electronic device.

Referring to FIG. 1 and FIG. 2B, after populating the editable legal disclosure 130, the system 100 may transfer the populated legal disclosure form to be an aggregate form 220 via the server 40. Specifically, the server 40 comprises a processor and a memory coupled to the processor.

The memory comprises an object-oriented program.

As shown in step 261, the server 40 may create a relationship between the editable legal disclosure form 130 and the aggregate form. It should be noted that the step 261 may also be done before the client 10 populates the editable legal disclosure 130, the present application is not limited thereto.

As shown in step 262, the system 100 may also confirm a file name extension of the legally pertinent file of the populated legal disclosure. Specifically, the system 100 may check the type of the file to make sure the file is in line with the official requirements. After that, the system 100 may transmit the populated legal disclosure form to the memory of the server 40.

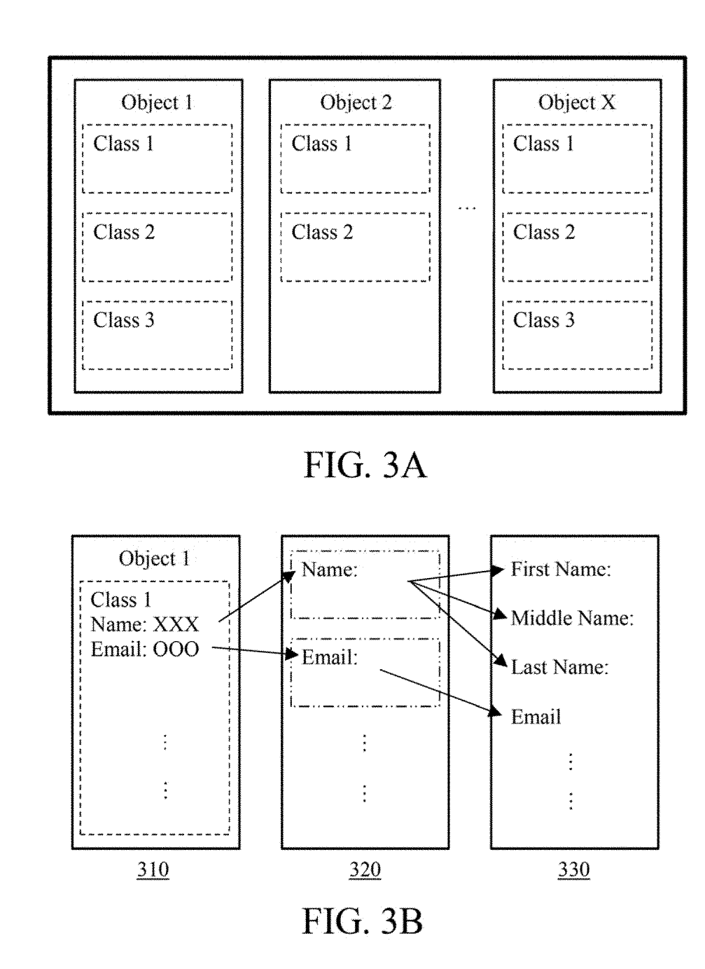

FIGS. 3A-3B illustrate views of an exemplary object-oriented program.

Steps 264 to 269 describe the object-oriented program done by the server 40. Specifically, as shown in FIG. 3A and step 264, the processor of the server 40 may create an object. for each client. For example, object 1 as shown in FIG. 3A may represent client 10.

After creating the object, the processor of the server 40 then create at least one class within the object as shown in step 265. For example, class 1 as shown in FIG. 3A may represent immigration cases; class 2 may represent patent cases; and class 3 may represent trademark case. However, the present application is not limited, each object may comprise more than two or three classes.

As shown in step 266, the server 40 then may classify the client 10 into the object according to the personal information part . Specifically, if the information of the client 10 is not existed in the server 40, the server 40 may create a new object for the client 10. However, if the information of the client 10 is already existed in server 40, the server may automatically jump to the object of the client 10 for proceeding the following steps.

As shown in step 267, the server 40 then classify the legal matter into the class according to the legal information part. For example, if the client 10 fill in the immigration portion of the editable legal disclosure 130, the server 40 may classify this legal matter into the class 1 which means immigration cases class.

As shown in step 268, the server 40 may extract information from the populated legal disclosure form into an aggregate data. For example, as shown in FIG. 3B, the left box 310 shows the information of the object and the class collected from the client 10; and the middle box 320 shows the aggregate data. The server 40 may extract the needed information to the corresponding portion of the aggregate data.

As shown in step 269, the server 40 then may compile the aggregate data into the aggregated form. For example, as shown in FIG. 3H, the right box 330 means the official aggregated form. The server 40 may extract the needed information from the aggregate data to the corresponding portion of the aggregate form. The aggregate form is an official form which is acceptable for the official agency.

Referring to FIG. 1 and FIG. 2C, the system 100 may print the aggregate form and send the aggregate form to the legal entity 30. Specifically, a printer 50 is connected to the server 40. If the client 10 upload anything which is not that necessary for seriously reviewing such as only a signature, the system 100 may automatically recognize and print it out depending on the portions of the populated legal disclosure form. Specifically, if the system recognizes that the client 10 fill in the signature portion only, then the printer 50 may print the signature out directly. After printing, the legal professional 20 may make a simple review for confirmation as shown in step 280a. After reviewing, the system 100 may connect with the mail agent for sending the aggregated form to the legal entity 30 as shown in step 285.

Or, as shown in step 290, the legal professional 20 may also access the server 40 for reviewing the aggregated form. After reviewing, the legal professional 20 may send the aggregated form to the legal entity 30 or notify the client 10 for an additional information or send the aggregated form to the legal entity 30 as shown in step 295.

It should be noted that the present application is not limited in the legal entity 30. The aggregated form also can be sent to the third party. For instance, the aggregated form can be sent to the illustrator if it is a pattern that need further artistic modification; or the aggregated form can be sent to a public notary if notarization is required before filing.

Based on the above, the present application allows the client to choose the trusted legal professional in a more efficient way since the client can select the attorneys simply via the electronic device. In addition, due to the utilization of the object-oriented program, the populated legal disclosure form can be transferred into the aggregated form which is formal and clearer for the legal professional, reducing previous complex and time-consuming procedure. Furthermore, the client also does not need to read and fill in the complex official documents but populates the simple form, providing a more user friendly interface for the client.

It will be apparent to those skilled in the art that various r modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A method for collecting and populating forms between a client and a legal professional, comprising:
providing an editable legal disclosure form for the client;
populating the editable legal disclosure form by the client;
transferring the populated legal disclosure form to be an aggregated form via a server, wherein the server comprises a processor and a memory coupled to the processor, the memory comprises an object-oriented program; and
reviewing the aggregated form by the legal professional.

2. The method for collecting and populating forms between the client and the legal professional as claimed in claim 1, wherein before populating the editable legal disclosure form by the client, the method further comprises downloading the editable legal disclosure form by the client via an electronic device.

3. The method for collecting and populating forms between the client and the legal professional as claimed in claim 2, wherein the electronic device is a mobile communication device.

4. The method for collecting and populating forms between the client and the legal professional as claimed in claim 3, wherein the mobile communication device is a smart phone, a tablet of a digital personal assistant.

5. The method for collecting and populating forms between the client and the legal professional as claimed in claim 1, wherein the step of transferring the populated legal disclosure form to be the aggregated form via the server comprises:
creating a relationship between the editable legal disclosure form and the aggregated form, wherein the editable legal disclosure form comprises a personal information part, a legal information part and a legally pertinent file part, wherein the legal information part an legally pertinent file part relate to a legal matter;
transmitting the populated legal disclosure form to the memory;
creating an object for the client via the processor;
creating at least one class within the object is the processor;
classifying the client into the object according to the personal information part;
classifying the legal matter into the at least one class according to the legal information part;
extracting a personal information from the personal information part, a legal information from the legal information part and a legally pertinent file from the legally pertinent file part into an aggregate data; and
compiling the aggregate data into the aggregated form.

6. The method for collecting and populating forms between the client and the legal professional as claimed in claim 5, wherein after creating the relationship between the editable legal disclosure form and the aggregated form, the method further comprises confirming a filename extension of the legally pertinent file.

7. The method for collecting and populating forms between the client and the legal professional as claimed in claim 1, herein after transferring the populated legal disclosure form to be the aggregated form via the server, the method further comprises printing the aggregated form.

8. The method for collecting and populating forms between the client and the legal professional as claimed in claim 7, wherein after printing the aggregated form, the method further comprises sending the aggregated form to a legal entity.

9. The method for collecting and populating forms between the client and the legal professional as claimed in claim 1, wherein the step of providing the editable legal disclosure form for the client comprises providing a retainer agreement for the client.

10. The method for collecting and populating forms between the client and the legal professional as claimed in claim 9, wherein after providing a retainer agreement for the client, the method further comprises accepting the retainer agreement by the client.

11. The method for collecting and populating forms between the client and the legal professional as claimed in claim 9, wherein the retainer agreement comprises a full payment term.

12. The method for collecting and populating forms between the client and the legal professional as claimed in claim 9, wherein the retainer agreement comprises a partial payment term.

13. The method for collecting and populating forms between the client and the legal professional as claimed in claim 1, wherein before providing the editable legal disclosure form for the client, the method further comprises logging in to the server by the client.

14. The method for collecting and populating forms between the client and the legal professional as claimed in claim 1, wherein before providing the editable legal disclosure form for the client, the method further comprises selecting the legal professional by the client.

15. The method for collecting and populating forms between the client and the legal professional as claimed in claim 1, wherein after reviewing the aggregated form by the legal professional, the method further comprises notifying the client for an additional information by the legal professional.
